(19) United States
(12) Patent Application Publication
(10) Pub. No.: US 2019/0325531 A1
(43) Pub. Date: Oct. 24, 2019

(54) LOCATION-BASED CANDIDATE GENERATION IN MATCHING SYSTEMS

(71) Applicant: Microsoft Technology Licensing, LLC, Redmond, WA (US)

(72) Inventors: Matthew H. Walker, Mountain View, CA (US); Yiping Yuan, Sunnyvale, CA (US); Namit S. Katariya, Sunnyvale, CA (US)

(73) Assignee: Microsoft Technology Licensing, LLC, Redmond, WA (US)

(21) Appl. No.: 15/960,762

(22) Filed: Apr. 24, 2018

(51) Int. Cl. G06Q 50/00; G06F 17/30

(52) U.S. Cl. CPC G06Q 50/01; G06F 17/3053; G06F 17/3087; G06F 17/30867; G06F 17/3033

(57) ABSTRACT

The disclosed embodiments provide a system for processing data. During operation, the system obtains a set of vectors representing attributes of a set of entities. For each vector in the set of vectors, the system generates a set of signatures from the vector. The system also periodically modifies a technique for generating the set of signatures to update the set of signatures for the vectors. The system then uses the set of signatures to identify a subset of the vectors with a matching signature. Finally, the system outputs the subset of the vectors for use in selecting candidates for matching to an additional entity.

### BACKGROUND

### Field

The disclosed embodiments relate to matching and recommendation systems. More specifically, the disclosed embodiments relate to techniques for performing location-based candidate generation in matching systems.

### Related Art

Online networks may include nodes representing entities such as individuals and/or organizations, along with links between pairs of nodes that represent different types and/or levels of social familiarity between the entities represented by the nodes. For example, two nodes in an online network may be connected as friends, acquaintances, family members, and/or professional contacts. Online networks may further be tracked and/or maintained on web-based networking services, such as online professional networks that allow the entities to establish and maintain professional connections, list work and community experience, endorse and/or recommend one another, run advertising and marketing campaigns, promote products and/or services, and/or search and apply for jobs.

In turn, users and/or data in online professional networks may facilitate other types of activities and operations. For example, recruiters may use the online professional network to search for candidates for job opportunities and/or open positions. At the same time, job seekers may use the online professional network to enhance their professional reputations, conduct job searches, reach out to connections for job opportunities, and apply to job listings. Consequently, use of online professional networks may be increased by improving the data and features that can be generated, queried, updated, and/or accessed through the online professional networks.

### BRIEF DESCRIPTION OF THE FIGURES

FIG. 1 shows a schematic of a system in accordance with the disclosed embodiments.

FIG. 2 shows a system for processing data in accordance with the disclosed embodiments

FIG. 3 shows a flowchart illustrating the processing of data in accordance with the disclosed embodiments.

FIG. 4 shows a flowchart illustrating a process of generating signatures for a set of vectors representing attributes of a set of entities in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

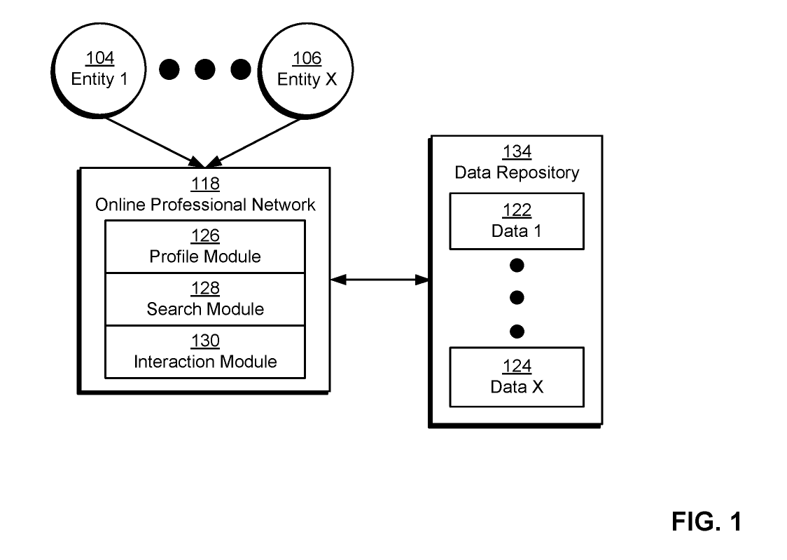

The disclosed embodiments provide a method, apparatus, and system for processing data. As shown in FIG. 1, the data may be associated with a user community, such as an online professional network 118 that is used by a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

More specifically, online professional network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online professional network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online professional network 118 also includes a search module 128 that allows the entities to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature in online professional network 118 to search for profiles, jobs, and/or information by categories such as first name, last name, title, company, school, location, interests, relationship, skills, industry, groups, salary, experience level, etc.

Online professional network 118 further includes an interaction module 130 that allows the entities to interact with one another on online professional network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest posts, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online professional network 118 may be tracked and stored in a database, data warehouse, cloud storage, and/or other data-storage mechanism providing data repository 134.

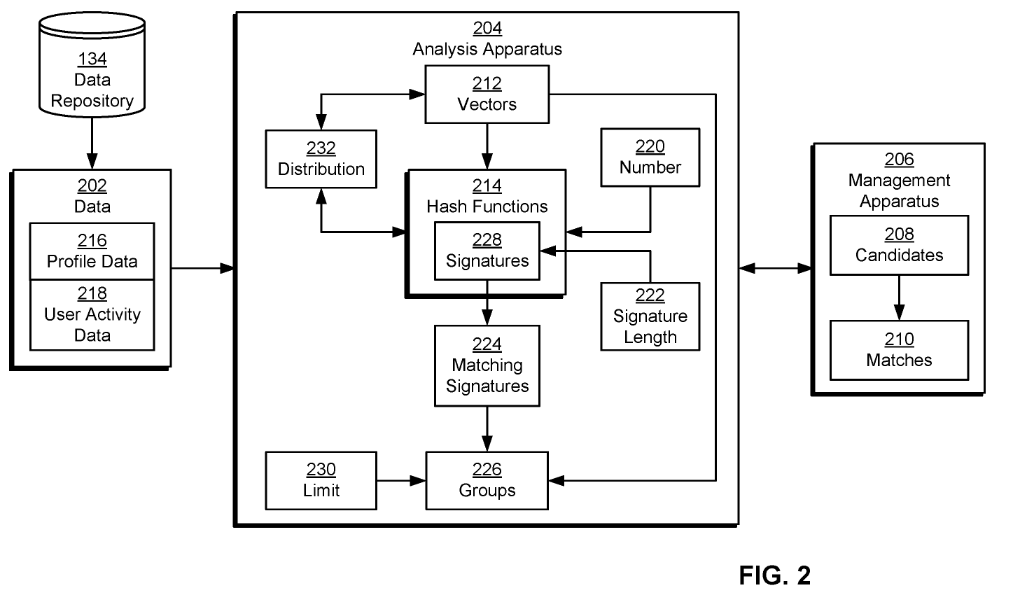

As shown in FIG. 2, data repository 134 and/or another primary data store may be queried for data 202 that includes profile data 216 for members of an online community (e.g., online professional network 118 of FIG. 1), as well as user activity data 218 that tracks the members' activity within and/or outside the online community. Profile data 216 includes data associated with member profiles in the online community. For example, profile data 216 for an online professional network may include a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 may also include a set of groups to which the user belongs, the user's contacts and/or connections, and/or other data related to the user's interaction with the online community.

Attributes of the members from profile data 216 may be matched to a number of member segments, with each member segment containing a group of members that share one or more common attributes. For example, member segments in the online community may be defined to include members with the same industry, title, location, and/or language.

Connection information in profile data 216 may additionally be combined into a graph, with nodes in the graph representing entities (e.g., users, schools, companies, locations, etc.) in the online community. In turn, edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

User activity data 218 includes records of member interactions with one another and/or content associated with the online community. For example, user activity data 218 may be used to track impressions, clicks, likes, dislikes, shares, hides, comments, posts, updates, conversions, and/or other user interaction with content in the online community. User activity data 218 may also track other types of activity, including connections, messages, and/or interaction with groups or events. Like profile data 216, user activity data 218 may be used to create a graph, with nodes in the graph representing online community members and/or content and edges between pairs of nodes indicating actions taken by members, such as creating or sharing articles or posts, sending messages, sending or accepting connection requests, joining groups, and/or following other entities.

In one or more embodiments, profile data 216 and/or user activity data 218 are used to generate a set of candidates 208 in a matching or recommendation system. For example, data 202 in data repository 134 may be used with a “Career Advice” product in an online professional network (e.g., online professional network 118 of FIG. 1) and/or another community of users. The product may allow members of the community to search for, connect with, and/or reach out to other members with the goal of giving and/or receiving career-based advice, guidance, and/or mentorship. As a result, data 202 may be analyzed to identify candidates 208 as potential mentors for a mentee and/or potential mentees for a mentor. In another example, data 202 may be used to recommend jobs to the members, members as candidates for the jobs, and/or career services offered through the community to the members. In a third example, data 202 may be used to match members to products, groups, content, features, and/or other entities in which the members may be interested.

An analysis apparatus 204 uses data 202 to obtain and/or generate a set of vectors 212 representing entities (e.g., members, jobs, services, companies, etc.) in the community. Elements and/or dimensions of vectors 212 may encode and/or represent attributes in profile data 216, user activity data 218, and/or other data 202 in data repository 134. For example, a vector for a user may include three elements that encode the user's location as x, y, and z coordinates on a unit sphere representing the Earth. The coordinates may be generated by projecting the latitude and longitude of the location (e.g., as obtained from profile data 216 for the user) onto the unit sphere. In another example, the vector may include representations of the latitude and longitude, in lieu of or in addition to the corresponding x, y, and z coordinates in the unit sphere. In a third example, a member's profile data 216, user activity data 218, explicit or inferred preferences, and/or other attributes may be encoded into a set of elements in a vector representing the member.

Next, analysis apparatus 204 uses a set of hash functions 214 to generate a set of signatures 228 from each vector. Each signature may include one or more hash values from a group of hash functions 214. As a result, the signature may represent and/or identify a partition to which the vector belongs in a multidimensional space occupied by vectors 212.

For example, each hash function may be a sign-projection function with the following representation:

$${h}_{v} ( x ) = \frac{x \cdot v}{\vert x \cdot v \vert} .$$

In the above representation, a hash function h is parameterized by a vector v. The hash function may calculate a hash value from another vector x (e.g., vectors 212) to produce a value of +1 or −1, depending on the position of x relative to a hyperplane defined by v.

A set of different hash functions 214 may be applied to each vector to generate a set of hash values that form a signature for the vector. Continuing with the previous example, a set of N sign-projection hash functions 214 may be used to produce N hash values from the vector. The hash values may be stored in an N-dimensional signature for the vector, with each element of the signature populated with a value of +1 or −1 from the corresponding hash function. The signature may thus have 2\hat{ }N possible values, with each value of the signature representing a different partition of the space defined by the N hyperplanes represented by hash functions 214.

In addition, hash functions 214 and/or signatures 228 may be generated based on a number of parameters. First, hash functions 214 may be selected to increase a distribution 232 of vectors 212 across partitions in the space. Continuing with the previous example, each hash function may be generated by randomly sampling two vectors 212 from the set of vectors 212 and calculating the hash function as a vector that bisects the sampled vectors 212, thereby placing the two vectors in separate partitions. A formula for calculating a vector v that parameterizes the hash function may include the following representation:

a=x₁+x₂

v=a×(a×x₁)

In the above representation, x₁ and x₂ are the two sampled vectors 212, and x is a vector cross product.

Second, the number of signatures 228 produced from each vector may be affected by a number 220 of hash functions 214 and a signature length 222 of each signature. For example, the generation of signatures 228 from vectors 212 may represented by M=H/N, where M represents the number of signatures 228 produced for each vector, H represents a total number 220 of hash functions 214 used to calculate each set of signatures 228, and N represents signature length 222 (i.e., the number of hash values in each signature). In turn, the multidimensional space of vectors 212 may be partitioned 2\hat{ }N*M different ways.

After signatures 228 are generated for all vectors 212, analysis apparatus 204 uses matching signatures 224 among vectors 212 to identify groups 226 of entities with the same signatures 228. Continuing with the previous example, analysis apparatus 204 may identify, for each of the 2\hat{ }N*M partitions generated using signatures 224, a subset of vectors 212 in the partition as vectors 212 that share a signature representing the partition. Analysis apparatus 204 may then identify entities represented by the subset of vectors 212 and include the entities in a group that is identified using the partition and/or signature. Because the partition identifies the entities as having “similar” vector representations of attributes, the entities may be considered “neighbors” within the partition and/or identified as related or similar to one another.

Analysis apparatus 204 also applies a limit 230 to the size of groups 226. For example, limit 230 may represent a maximum number of entities in each group. When the number of entities in the group does not exceed the maximum number, analysis apparatus 204 may retain all entities in the group. When the number of entities in the group exceeds the maximum number, analysis apparatus 204 may replace the group with a random sample of up to the maximum number of entities in the group.

Analysis apparatus 204 then uses groups 226 to select one or more sets of candidates 208 for matching to additional entities. For example, analysis apparatus 204 may use groups 226 of entities as potential mentors (or mentees) for additional entities representing potential mentees (or mentors). As a result, some or all entities in a group may be included as candidates 208 for matching to an entity with a vector that is in the same partition and/or that produces the same matching signature as the group. In another example, analysis apparatus 204 may use groups 226 of jobs as potential recommendations for a job seeker. In turn, some or all jobs in a group may be identified as candidates 208 for matching to a job seeker with a vector that is in the same partition and/or that produces the same matching signature as the group.

Parameters used by analysis apparatus 204 to identify candidates 208 may further be selected and/or tuned to balance the number of entities in groups 226, the median vector “distance” between entities in each group, and/or computational overhead associated with generating groups 226. For example, numbers 220 of hash functions 214, signature length 222, and/or limit 230 may be selected to control the amount of overlap in partitions represented by signatures 228, the number of candidates 208 generated for a given entity in a partition, the dimensionality associated with the partitions, and/or the extent to which candidates 280 that are close to a given entity in the vector space are identified using the partitions.

Finally, management apparatus 206 uses candidates 208 to generate matches 210 for the additional entities. For example, management apparatus 206 may use vectors 212 for potential mentors or mentees in a partition to calculate a set of similarities between mentor-mentee pairs in the partition. The similarities may be calculated as Euclidean distances, cosine similarities, Jaccard similarities, and/or other measures of vector similarity. Management apparatus 206 may also rank the mentor-mentee pairs by calculated similarity and use the ranked mentor-mentee pairs to select one or more pairs as matches 210.

Continuing with the example, management apparatus 206 may select, from the ranking, a certain number of mentor-mentee pairs with the highest measures of similarity and/or a variable number of mentor-mentee pairs with similarities that exceed a threshold. Next, management apparatus 206 may use a machine learning model and/or other scoring technique to rate the selected mentor-mentee pairs by additional attributes such as relative experience levels, relative seniority levels, similarity in work experience and/or roles, and/or similarity in educational background. Management apparatus 206 may then use a set of constraints and/or filters associated with the mentors and/or mentees to identify one or more of the highest-scoring mentor-mentee pairs as matches 210. Finally, management apparatus 206 and/or another component of the system may output matches 210 as recommendations to the corresponding mentor-mentee pairs to allow the mentors and mentees to engage with one another, obtain and/or exchange career-related advice, and/or conduct other interactions related to mentorship and/or career guidance.

The process may be repeated to generate new and/or different sets of candidates 208 for matching to various entities. For example, analysis apparatus 204 may select a new set of hash functions 214 for partitioning the space of vectors 212 on a daily, weekly, and/or other periodic basis. Analysis apparatus 204 may also use the new set of hash functions 214 to generate a new set of signatures 228 for each vector and use new matching signatures 224 to generate new groups 226 of entities as candidates 208 for matching with other entities. As a result, a given entity may be exposed to different potential matches 210 over time instead of a single static set of matches 210 generated from partitions that are defined using the same set of hash functions 214.

In one or more embodiments, the system of FIG. 2 is used to perform location-based candidate generation for matching of mentors to mentees. For example, the system may identify candidates 208 as potential mentor matches 210 for mentees and/or potential mentee matches 210 for mentors in a “Career Advice” product, application, or community. In this context, analysis apparatus 204 may use vectors 212 containing x, y, and z coordinates representing user locations on unit sphere. Analysis apparatus 204 may also select hash functions 214 to bisect the locations of random pairs of users, thus distributing the user base into geographic partitions of the unit sphere more efficiently than grid-based partitioning of geographic areas.

After groups 226 of users are generated from the corresponding vectors 212 with matching signatures 224 from hash functions 214, analysis apparatus 204 may obtain, from each group, users who have registered as mentors as candidates 208 for matching with mentees in the same group (i.e., mentees in the same geographic partition as the users). Analysis apparatus 204 may also, or instead, obtain users who have registered as mentees as candidates 208 for matching with mentors in the same group. In other words, analysis apparatus 204 may select candidates 208 based on the relative geographic proximity of candidates 208 to a mentee or mentor. Using this technique, a user who in a sparsely populated location can still be matched to other, more distantly located users as hash functions 214 are regenerated and used to define different geographic partitions over time.

By using hash functions 214 to partition a vector space of vectors 212 representing attributes of entities and generate candidates 208 based on groups 226 of entities in the partitions, the system of FIG. 2 may reduce the computational complexity associated with identifying candidates 208 for matches 210 using every possible combination of candidates 208 with entities to which candidates 208 are to be matched. At the same time, candidates 208 identified by the system may have higher similarity to the entities than techniques that randomly generate candidate pairs and/or use randomly generated hash functions to partition metric spaces. Moreover, changes to hash functions 214 may allow potential matches 210 to surface over time as the space of vectors 212 is partitioned in different ways and used to generate different groups 226 of “related” or “similar” entities. Consequently, the system of FIG. 2 may improve the performance, efficiency, and use of computer systems, applications, and/or technologies for generating recommendations and/or connecting users via online communities and/or network-enabled devices.

Those skilled in the art will appreciate that the system of FIG. 2 may be implemented in a variety of ways. First, analysis apparatus 204, management apparatus 206, and/or data repository 134 may be provided by a single physical machine, multiple computer systems, one or more virtual machines, a grid, one or more databases, one or more filesystems, and/or a cloud computing system. Analysis apparatus 204 and management apparatus 206 may additionally be implemented together and/or separately by one or more hardware and/or software components and/or layers.

Second, profile data 216, user activity data 218, and/or other data 202 used to generate vectors 212, groups 226, candidates 208 and/or matches 210 may be obtained from a variety of sources. As mentioned above, the data may be obtained and/or tracked within a social network and/or other community of users. Alternatively, some or all of the data may be obtained from other applications, user interactions, and/or public records.

Third, various techniques may be used to reduce the search space for identifying candidates 208 in a matching or recommendation context from representations of attributes in data 202. For example, the system may use a locality-sensitive hashing technique, Bloom filter, principal component analysis technique, and/or random projection technique, and/or another technique for reducing the dimensionality of entities and/or entity pairs that can be used to generate a set of candidates 208 for performing matching among the entities and/or entity pairs.

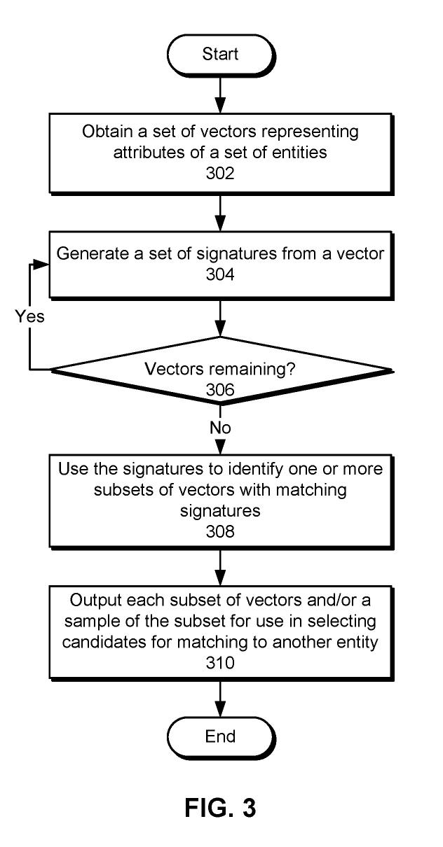

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a set of vectors representing attributes of a set of entities is obtained (operation 302). For example, the entities may include members, companies, jobs, schools, groups, products, services, content, and/or other entities in an online professional network or online community. The attributes may include locations, industries, skills, titles, seniorities, connections, schools, companies, and/or groups associated with the entities.

Each attribute may be encoded into and/or represented using one or more dimensions of a corresponding vector. For example, a location of an entity may be represented in the vector as x, y, and z coordinates on a unit sphere and/or a latitude and longitude. In another example, representations of reputation scores, skills, interests, groups, companies, schools, industries, positions, seniorities, locations, preferences, goals, and/or other attributes associated with members of an online professional network may be included in one or more elements of vectors representing the members.

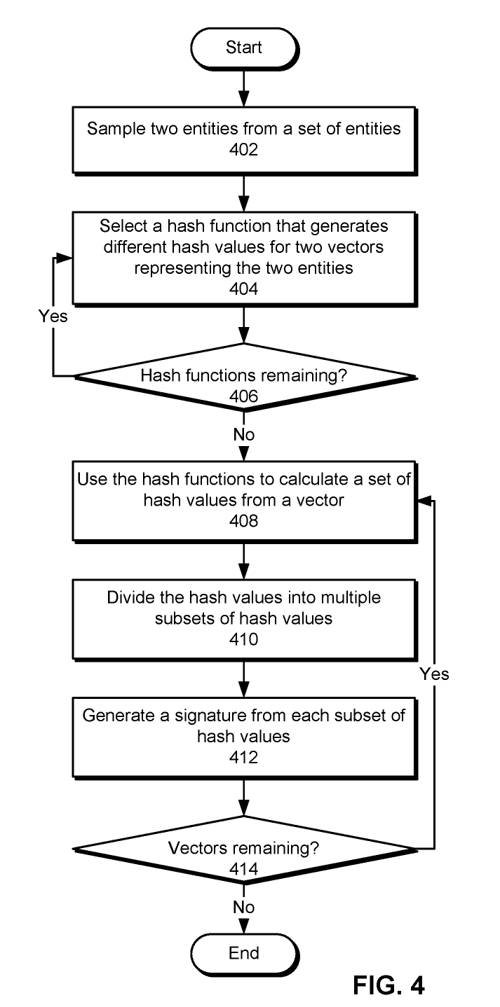

Next, a set of signatures is generated from a vector (operation 304) in the set of vectors, as described in further detail below with respect to FIG. 4. Operation 304 may be repeated for remaining vectors (operation 306) in the set to calculate multiple sets of signatures for multiple vectors representing the entities. Operation 304 may also be periodically performed with a modified formula or technique for generating the signatures to update the signatures for each vector instead of maintaining the same set of signatures for the vector over time.

After the signatures for the vectors are generated and/or updated, the signatures are used to identify one or more subsets of vectors with matching signatures (operation 308), and each subset of vectors and/or a sample of the subset is outputted for use in selecting candidates for matching to another entity (operation 310). For example, the vectors may be grouped into subsets with matching signatures, with each grouped subset of vectors representing a different partition of the vector space. When a group of vectors is larger than a predefined maximum number of vectors, the group may be replaced with a random sample of up to the maximum number of vectors in the group.

To use the subset of vectors to select candidates as potential matches for a given entity, a set of signatures for a vector representing the entity is examined for the matching signature associated with the subset of entities. When the matching signature is found in the set of signatures, the entity's vector is identified as a member of the same partition as the subset of vectors. Vectors in the partition may then be used to calculate a set of similarities between entities represented by the subset of vectors and the entity. The subset of the entities may then be ranked by the set of similarities, and the ranked subset of the entities may be used to select one or more matches for the entity (e.g., based on additional scores between highest-ranked entities in the subset and the other entity).

FIG. 4 shows a flowchart illustrating a process of generating signatures for a set of vectors representing attributes of a set of entities in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, two entities are sampled from a set of entities (operation 402). For example, the entities may be randomly selected from the set and/or selected based on similarity or dissimilarity in the entities' attributes. Next, a hash function that generates different hash values for two vectors representing the two entities is selected (operation 404). For example, the hash function may be generated as a vector that bisects the two vectors. As a result, the hash function may place the two vectors in different partitions and produce a different value for each vector.

Operations 402-404 may be repeated for remaining hash functions (operation 406) used to generate the signatures. For example, pairs of entities may be sampled and/or selected and used to select a hash function that produces different hash values for the entities' vectors until a pre-specified number of hash functions is produced.

The hash functions are then used to calculate a set of hash values from a vector (operation 408), and a set of signatures is generated from the hash values. For example, each hash function may be a sign-projection function that produces a value of +1 or −1 for a vector, depending on which side the vector lies with respect to the hyperplane represented by the hash function.

To produce the set of signatures from the hash values, the hash values are divided into multiple subsets of hash values (operation 410), and a signature is generated from each subset of hash values (operation 412). For example, each subset of hash values may be concatenated into a corresponding signature for the vector. The set of signatures may also be generated based on a signature length that specifies the number of hash values to include in the signature and/or a number of hash functions used to calculate the set of hash values for each vector. Operations 408-412 may be repeated for remaining vectors (operation 414) in a set of vectors, such as a set of vectors representing entities in a social network and/or online community.

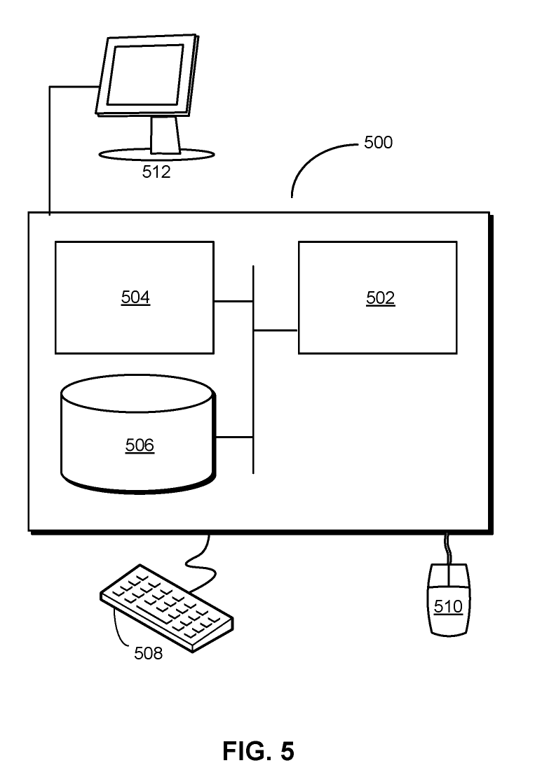

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system includes an analysis apparatus and a management apparatus, one or more of which may alternatively be termed or implemented as a module, mechanism, or other type of system component. The analysis apparatus obtains a set of vectors representing attributes of a set of entities. For each vector in the set of vectors, the analysis generates a set of signatures from the vector. The analysis apparatus also periodically modifies a formula for generating the set of signatures to update the set of signatures for the vector. The analysis apparatus then uses the set of signatures to identify a subset of the vectors with a matching signature. Finally, the analysis apparatus and/or management apparatus output the subset of the vectors for use in selecting candidates for matching to an additional entity.

In addition, one or more components of computer system 500 may be remotely located and connected to the other components over a network. Portions of the present embodiments (e.g., analysis apparatus, management apparatus, data repository, online professional network, etc.) may also be located on different nodes of a distributed system that implements the embodiments. For example, the present embodiments may be implemented using a cloud computing system that generates and/or recommends matches between remote entities in an online network.

By configuring privacy controls or settings as they desire, members of a social network, online professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of vectors representing attributes of a set of entities;
for each vector in the set of vectors, generating, by a computer system, a set of signatures from the vector;
periodically modifying a technique for generating the set of signatures to update the set of signatures for the vectors;
using the set of signatures to identify, by the computer system, a subset of the vectors with a matching signature; and
outputting the subset of the vectors for use in selecting candidates for matching to an additional entity.

2. The method of claim 1, further comprising:
using the set of signatures to identify a larger subset of the vectors with another matching signature; and
outputting a sample of the larger subset of the vectors as additional candidates for matching in the two-sided marketplace.

3. The method of claim 1, wherein generating the set of signatures from the vector comprises:
using a set of hash functions to calculate a set of hash values from the vector; and
generating the set of signatures from the set of hash values.

4. The method of claim 3, wherein generating the set of signatures from the vector further comprises:
selecting the set of hash functions to increase a distribution of the set of vectors across the set of signatures.

5. The method of claim 4, wherein selecting the set of hash functions to increase the distribution of the set of vectors across the set of signatures comprises:
sampling two entities in the set of entities; and
selecting a hash function that generates different hash values for two vectors representing the two entities.

6. The method of claim 3, wherein generating the set of signatures from the set of hash values comprises:
dividing the set of hash values into multiple subsets of the hash values; and
generating a signature from each subset of hash values in the multiple subsets of hash values.

7. The method of claim 3, wherein the set of signatures is generated based on at least one of:
a signature length comprising a number of hash values to include in the signature; and
a number of hash functions used to calculate the set of hash values.

8. The method of claim 1, wherein selecting the candidates for matching to the additional entity comprises:
using the subset of the vectors and a vector representing the additional entity to calculate a set of similarities between a subset of the entities and the additional entity;
ranking the subset of the entities by the set of similarities; and
using the ranked subset of the entities to select one or more matches for the additional entity.

9. The method of claim 1, wherein the set of signatures for the vector comprises the matching signature associated with the subset of the vectors.

10. The method of claim 1, wherein the set of vectors comprises a three-dimensional representation of a location.

11. The method of claim 1, wherein the set of entities comprises at least one of:
a set of mentors; and
a set of mentees.

12. A system, comprising:
one or more processors; and
memory storing instructions that, when executed by the one or more processors, cause the system to:
obtain a set of vectors representing attributes of a set of entities;
for each vector in the set of vectors, generate a set of signatures from the vector;
periodically modify a technique for generating the set of signatures to update the set of signatures for the vectors;
use the set of signatures to identify a subset of the vectors with a matching signature; and
output the subset of the vectors for use in selecting candidates for matching to an additional entity.

13. The system of claim 12, wherein the memory further stores instructions that, when executed by the one or more processors, cause the system to:
use the set of signatures to identify a larger subset of the vectors with another matching signature; and
output a sample of the larger subset of the vectors as additional candidates for matching in the two-sided marketplace.

14. The system of claim 13, wherein generating the set of signatures from the vector comprises:
using a set of hash functions to calculate a set of hash values from the vector; and
generating the set of signatures from the set of hash values.

15. The system of claim 14, wherein generating the set of signatures from the vector further comprises:
selecting the set of hash functions to increase a distribution of the set of vectors across the set of signatures.

16. The system of claim 15, wherein selecting the set of hash functions to increase the distribution of the set of vectors across the set of signatures comprises:
sampling two entities in the set of entities; and
selecting a hash function that generates different hash values for two vectors representing the two entities.

17. The system of claim 14, wherein generating the set of signatures from the set of hash values comprises:
dividing the set of hash values into multiple subsets of the hash values; and
generating a signature from each subset of hash values in the multiple subsets of hash values.

18. The system of claim 14, wherein the set of signatures is generated based on at least one of:
a signature length comprising a number of hash values to include in the signature; and
a number of hash functions used to calculate the set of hash values.

19. A non-transitory computer-readable storage medium storing instructions that when executed by a computer cause the computer to perform a method, the method comprising:
obtaining a set of vectors representing attributes of a set of entities;
for each vector in the set of vectors, generating a set of signatures from the vector;
periodically modifying a technique for generating the set of signatures to update the set of signatures for the vectors;
using the set of signatures to identify a subset of the vectors with a matching signature; and
outputting the subset of the vectors for use in selecting candidates for matching to an additional entity.

20. The non-transitory computer-readable storage medium of claim 19, wherein the method further comprises:
using the set of signatures to identify a larger subset of the vectors with another matching signature; and
outputting a sample of the larger subset of the vectors as additional candidates for matching in the two-sided marketplace.
